(19) United States
(12) Patent Application Publication
(10) Pub. No.: US 2002/0059525 A1
(43) Pub. Date: May 16, 2002

(54) Authenticating the contents of e-documents

(76) Inventors: Timothy A. Estes, Albuquerque, NM (US); Richard W. Esterly, Albuquerque, NM (US); Joel Todd Hendrickson, Albuquerque, NM (US)

Correspondence Address: Richard W. Esterly, 11232 Country Club Drive NE, Albuquerque, NM, 87111, US

(21) Appl. No.: 09/986,500

(22) Filed: Nov. 9, 2001

Related U.S. Application Data
(60) Provisional application No. 60/247,300, filed on Nov. 10, 2000.

(51) Int. Cl. H04L 9/00; H04L 9/32; G06F 11/30; G06F 12/14

(52) U.S. Cl. 713/200

(57) ABSTRACT

In sending email documents, a method for authenticating the email and attachment(s), is presented. The sender sends an original email, and attachment(s), to: the recipient(s), and an email copy, cc: to an authentication service. The authentication service encrypts the email and attachment(s); and returns the encrypted file to both the sender and the recipient(s). Either the sender or the recipients can return the encrypted file to the authentication service for unencryption and reproduction of the exact original email and attachment(s). Whoever returns the encrypted file for authentication will be notified that the file was either altered or the unencrypted contents (exact reproduction of original email and attachments) will be returned, via email. The sender and recipients require no additional software other than their existing email communication software running on a host electronics platform. The authentication service retains no data from the aforementioned process.

### FIELD OF THE INVENTION

The present invention relates to a method of authenticating the contents of e-mail, including attachments. More particularly, the present invention relates to a method of authentication based on the use of encryption technology.

### BACKGROUND OF THE INVENTION

Advances in technology and the dramatic growth of the Internet have allowed companies to perform increasing amounts of business electronically. The use of electronic mail is increasing at exponential rates, as businesses prefer to communicate electronically.

While companies increasingly prefer to perform business and correspondence via electronic mail, there are a number of inherent problems, including:

1) verification of the source of the communication;

2) ensuring the privacy of the communication;

3) certifying the delivery of the communication; and

4) ensuring the communication is not modified by the recipient.

The present invention solves the fourth problem listed above.

### PRIOR ART

Ensuring that an email communication has not modified by the recipient can be accomplished whereby both the sender and/or recipient implement extraneous software dedicated for secure transfer. One such example is “Zixmail” located at www.zixit.com. Either the sender or both sender/receiver require zixit technology (patent pending) software for ensuring email communication. Another company, www.verisign.com also offers a similar service; however, extraneous, dedicated software (patent pending) is a requirement.

Another method for ensuring email communication is accomplished by digitally fingerprinting. In this manner, an email document can be electronically assessed to be the original within a statistical tolerance; however, the exact original is not reproduced. A company, located at www.rpost.com provides a patent pending email authentication service that does not require extraneous software. The Rpost service provides a digital fingerprint of the original, contained within a digital email receipt. The receipt can later be assessed by Rpost for authentication. Rpost makes no claim for reproduction of the exact original email and attachment(s).

### SUMMARY OF THE INVENTION

This invention relates to a method of authenticating, via an authentication service, the contents of an e-document (i.e., e-mail with or without attachments) sent by an originator to at least one addressee. The method includes the steps of: sending, via e-mail, the e-document to the addressee; sending, via e-mail, a copy of the e-document to the authentication service; encrypting the copy of the e-document by the authentication service; and sending, via e-mail, the encrypted e-document to the originator and any addressee identified by the originator. During the steps of encrypting and sending by the authentication service, no copy of the e-document or the encrypted e-document is retained by the authentication service. Additionally, no information on the e-document or the encrypted e-document is retained by the authentication service. Thus, for subsequent authentication, the encrypted copy must be saved by one or more of the originator and any identified addressee. With at least one encrypted copy saved, the method further includes the steps of: sending, via e-mail, the encrypted e-document to the authentication service; decrypting the encrypted e-document; and sending, via e-mail, the decrypted document to both the originator (of the encrypted e-document) and any identified addressee. Again, no copies are retained by the authentication service. Prior to decrypting, the authentication service determines whether the encrypted e-document as received from the originator (or an addressee) has been modified. Decrypting only takes place if the encrypted e-document has not been modified. Finally, if the encrypted e-document has been modified, the process includes the step of notifying the originator (of the encrypted e-document) and any identified addressee that the encrypted e-document as received by the authenticator has been modified and cannot be decrypted.

### BRIEF DESCRIPTION OF THE DRAWINGS

FIG. 1 is a diagramitical representation of the process of originating and creating an encrypted copy of an original e-document; and

FIG. 2 is a diagramitical representation of the authenticating process (of the encrypted copy) of the present invention.

### DESCRIPTION OF THE PREFERRED EMBODIMENT

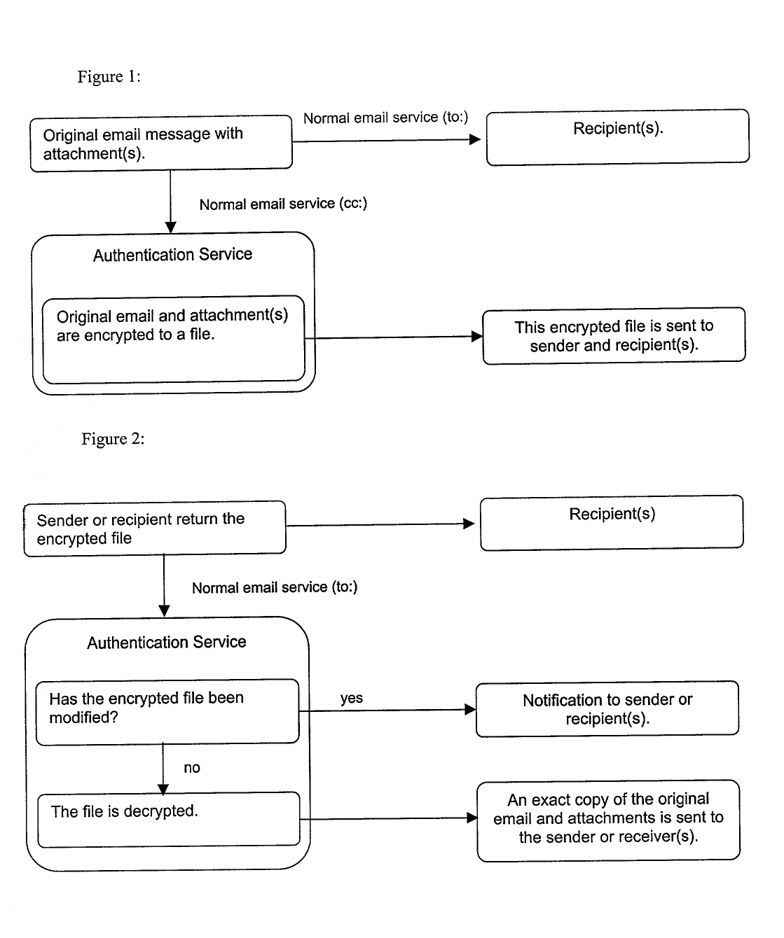

With reference to FIG. 1 the authenticating process of the present invention starts with the originator's transmission of an e-document (i.e., e-mail with or without attachments) to the intended recipient or recipients via normal e-mail service, with a copy sent by e-mail to the authentication service (e.g., eCopyMe.com). Using encryption software (e.g., commercially available software for encryption), an encrypted file of the original e-document is created. Once encrypted, the encrypted file is sent, again by normal e-mail service, to both the originator and any recipient(s), which was identified by the originator to the authentication service. No copy of the original e-document or the encrypted file is retained by the authentication service. Further, no information on the original e-document or the encrypted e-document is retained by the authentication service.

The authenticating process of the present invention is illustrated in FIG. 2. To initiate this process, the original sender (or a recipient who has a copy of the encrypted file) sends the encrypted file to the authentication service as an attachment to an e-mail. A copy of the encrypted file can, at the option of the party originating decrypting, be sent to any other party (e.g., originator of the e-document, recipient, third party). Once received, the encrypted file is decrypted, by appropriate decryption software, and a copy of the original e-document(s) sent to both the party requesting decryption and any third party identified to the authentication service by the requesting party.

According to the present invention, only encrypted files that have not been altered are authenticated. If an encrypted file has been altered, the decryption software will detect such alteration and the file with the encrypted e-document will not be decrypted. Notification of receipt of a file with an altered encrypted e-document will be sent to the party that requested decryption and any other party(ies) identified to the authentication service on the request to decrypt.

Whereas the drawings and accompanying description have shown and described the preferred embodiment of the present invention, it should be apparent to those skilled in the art that various changes may be made in the form of the invention without affecting the scope thereof.

### Conclusions, Ramifications, and Scope

The process, which is the scope of this patent application, is a novel utility process for authenticating e-mail documents by encrypting/processing the original(s) and subsequently decrypting/reprocessing and reproducing the exact original(s) for discrepancy resolution between the sender and recipient(s). Both the sender and recipient(s) can be mutually assured that their encrypted/processed “authentication file,” sent from the authentication service, will not be altered so that the exact original(s) can be reproduced to legitimize any e-mail agreement or transaction based on the original e-document(s).

The purpose for encrypting the original(s) is for transforming them into an encrypted/processed file where the contents are opaque (unrecognizable) to both the sender and recipient(s). The encryption, or processing, complicates the task of altering the original(s); therefore, the sender and recipient(s) confidence is improved when conducting an e-mail agreement or transaction.

Another advantage of the process of this patent application is that the sender and recipient(s) can utilize this process without using any software other than what they are currently using to communicate electronically.

Both the sender and receiver can also be mutually assured that the authentication service, that provides the encryption/processing process of this patent application, retains no data and is a “pass-through” service.

1. A method of authenticating, via an authentication service, the contents of an document sent by an originator to at least one addressee, said method including the steps of:
(a) sending, via e-mail, said e-document to said addressee;
(b) sending, via e-mail, a copy of said e-document to said authentication service;
(c) encrypting said copy of said e-document;
(d) sending, via e-mail, said encrypted e-document to said addressee; and
(e) sending, via e-mail, said encrypted e-document to said originator.

2. The method of claim 1, wherein during the steps of encrypting and sending by said authentication service, no copy of said e-document or said encrypted e-document is retained by said authentication service.

3. The method of claim 1, wherein during the steps of encrypting and sending by said authentication service, no information on said e-document or said encrypted e-document is retained by said authentication service.

4. The method of claim 1, further including the step of saving said encrypted e-document by one or more of said originator and said addressee.

5. The method of claim 4, further including the steps of:
(a) sending, via e-mail, said encrypted e-document to said authentication service;
(b) decrypting said encrypted e-document by said authentication service; and
(c) sending, via e-mail, said decrypted document to said originator and said addressee.

6. The method of claim 5, further including the step of, prior to said decrypting, determining whether said encrypted e-document as received by said authentication service has been modified, and decrypting only said encrypted e-document if it has not been modified.

7. The method of claim 6, further including the step of notifying said originator and said address that said encrypted e-document as received by said authentication service has been modified and cannot be decrypted.
